(19) United States
(12) Patent Application Publication
(10) Pub. No.: US 2015/0231955 A1
(43) Pub. Date: Aug. 20, 2015

(54) VEHICLE WINDSHIELD PROTECTION DEVICE

(71) Applicant: DELK PRODUCTS, INC., Nashville, TN (US)

(72) Inventor: Raymond Don Barnes, JR., Nashville, TN (US)

(73) Assignee: DELK PRODUCTS, INC., Nashville, TN (US)

(21) Appl. No.: 14/185,125

(22) Filed: Feb. 20, 2014

(51) Int. Cl. B60J 11/08

(52) U.S. Cl. CPC B60J 11/08

(57) ABSTRACT

A vehicle windshield protective device. The device may comprise: a cover portion, side mirror straps, a wind strap, one or more extra loops, and/or one or more full side straps. The cover portion may substantially cover an outer surface of a windshield of a vehicle. The side mirror straps may engage with one or more side mirrors of said vehicle. The wind strap may engage with a top portion of a vehicle and may prevent the device from being blown off the vehicle. The cover portion is generally configured to prevent frost, ice, and snow from adhering to said windshield.

### FIELD OF THE INVENTION

The present disclosure generally relates to devices for covering glass in order to protect the glass from the elements. More particularly, the present disclosure generally relates to a vehicle windshield cover that prevents ice, snow, and frost from covering the vehicles front windshield during non-use of the vehicle.

### BACKGROUND OF THE INVENTION

Currently, several commercially available products are available for preventing ice, snow, and frost build-up on the windshield of a parked vehicle, such as a car. However, these products are deficient because: (1) they generally fail to securely stay in place during strong wind gusts; (2) they generally fail to cover the entire windshield; and (3) they are usually made from inferior materials.

Thus, what is needed is an improved windshield cover that fully and firmly covers the entire windshield of a vehicle.

### SUMMARY OF THE INVENTION

To minimize the limitations in the prior art, and to minimize other limitations that will become apparent upon reading and understanding the present specification, the present disclosure discloses a new and useful vehicle windshield protection device.

One embodiment may be a vehicle windshield protective device, comprising: at least one cover portion; one or more side mirror straps; and at least one wind strap. The cover portion is configured to substantially cover an outer surface of a windshield of a vehicle. The side mirror straps are configured to engage with one or more side mirrors of the vehicle. The wind strap prevents the vehicle windshield protective device from being blown off the vehicle. The cover portion substantially prevents frost, ice, and snow from adhering to the windshield. The device may also comprise: a windshield wiper flap, which substantially prevents frost, ice, and snow from adhering to one or more windshield wipers. The device may also comprise one or more full side straps; which may be configured to engage with one or more side mirrors of the vehicle. The cover portion may be comprised of a Polyvinyl Chloride coating, such that the at least one cover portion remain flexible in temperatures below 0° C. The one or more side mirror straps, the at least one wind strap, and the one or more full side straps may be elastic, such that the at least one cover portion is held tightly in place on the windshield. Alternatively, the wind strap may be removably connected to the at least one cover portion. Alternatively, the cover portion may be further comprised of one or more wind strap attachments, which act as an attachment point between the cover portion and the wind strap. The wind strap may pass through an interior of the vehicle.

Another embodiment may be a vehicle windshield protective device, comprising: at least one cover portion; one or more side mirror straps; and one or more full side straps. The cover portion is configured to substantially cover an outer surface of a windshield of a vehicle. The side mirror straps are configured to engage with one or more side mirrors of the vehicle. The full side straps are configured to engage with one or more side mirrors of the vehicle. The cover portion substantially prevents frost, ice, and snow from adhering to the windshield. The device may further comprise a windshield wiper flap, which substantially prevents frost, ice, and snow from adhering to one or more windshield wipers. The device may further comprise at least one wind strap, which prevents the vehicle windshield protective device from being blown off the vehicle. Alternatively, the one wind strap may be removably connected to the cover portion. Alternatively, the cover portion may be further comprised of one or more wind strap attachments, to which the wind strap may be removably connected. The wind strap may pass through an interior of the vehicle. The cover portion may be comprised of a Polyvinyl Chloride coating, such that the at least one cover portion remain flexible in temperatures below 0° C. The one or more side mirror straps, the at least one wind strap, and the one or more full side straps are elastic, such that the at least one cover portion is held tightly in place on the windshield.

Another embodiment of the device may be a vehicle windshield protective device, comprising: at least one cover portion; a windshield wiper flap; one or more full side straps; one or more side mirror straps; and at least one wind strap; wherein the at least one cover portion is further comprised of one or more wind strap attachments; wherein the at least one wind strap is removably connected to the at least one cover portion at the one or more wind strap attachments; wherein the one or more wind strap attachments pass through an interior of the vehicle; wherein the at least one cover portion is configured to substantially cover an outer surface of a windshield of a vehicle; wherein the one or more side mirror straps are configured to engage with one or more side mirrors of the vehicle; wherein the at least one wind strap prevents the vehicle windshield protective device from being blown off the vehicle; wherein the cover portion substantially prevents frost, ice, and snow from adhering to the windshield; wherein the windshield wiper flap substantially prevents frost, ice, and snow from adhering to one or more windshield wipers; wherein the one or more full side straps are configured to engage with one or more side mirrors of the vehicle; wherein the at least one cover portion is comprised of a Polyvinyl Chloride coating, such that the at least one cover portion remain flexible in temperatures below 0° C.; and wherein one or more side mirror straps, the at least one wind strap, and the one or more full side straps are elastic, such that the at least one cover portion is held tightly in place on the windshield.

Another embodiment is an improved vehicle windshield protective device comprising at least one cover portion, one or more side mirror straps, the improvements comprising: one or more mirror covers; wherein the at least one cover portion is configured to substantially cover an outer surface of a windshield of a vehicle; wherein the one or more side mirror straps are configured to engage with one or more side mirrors of the vehicle; wherein the one or more full side straps are configured to engage with one or more side mirrors of the vehicle; wherein the cover portion substantially prevents frost, ice, and snow from adhering to the windshield; and wherein the one or more mirror covers are configured to substantially cover wherein the at least one cover portion is configured to substantially cover an outer surface of a windshield of a vehicle; wherein the one or more side mirror straps are configured to engage with one or more side mirrors of the vehicle; wherein the one or more full side straps are configured to engage with one or more side mirrors of the vehicle; wherein the cover portion substantially prevents frost, ice, and snow from adhering to the windshield. The device may further comprise a windshield wiper flap; wherein the windshield wiper flap substantially prevents frost, ice, and snow from adhering to one or more windshield wipers; and wherein the one or more mirror covers are removable.

Another embodiment of the device may be an improved vehicle windshield protective device comprising at least one cover portion, one or more side mirror straps, the improvements comprising: at least one wind strap; wherein the at least one cover portion is configured to substantially cover an outer surface of a windshield of a vehicle; wherein the one or more side mirror straps are configured to engage with one or more side mirrors of the vehicle; wherein the at least one wind strap prevents the vehicle windshield protective device from being blown off the vehicle; wherein the cover portion substantially prevents frost, ice, and snow from adhering to the windshield.

Another embodiment of the device may be an improved vehicle windshield protective device comprising at least one cover portion, one or more side mirror straps, the improvements comprising: one or more full side straps; wherein the at least one cover portion is configured to substantially cover an outer surface of a windshield of a vehicle; wherein the one or more side mirror straps are configured to engage with one or more side mirrors of the vehicle; wherein the one or more full side straps are configured to engage with one or more side mirrors of the vehicle; wherein the cover portion substantially prevents frost, ice, and snow from adhering to the windshield.

Another embodiment may be an improved vehicle windshield protective device comprising at least one cover portion and one or more side mirror straps, the improvements comprising: at least one wind strap; wherein the at least one cover portion is configured to substantially cover an outer surface of a windshield of a vehicle; wherein the one or more side mirror straps are configured to engage with one or more side mirrors of the vehicle; wherein the at least one wind strap prevents the vehicle windshield protective device from being blown off the vehicle; wherein the cover portion substantially prevents frost, ice, and snow from adhering to the windshield. The device may further comprise: a windshield wiper flap; wherein the windshield wiper flap may be configured to substantially cover one or more windshield wipers of a vehicle when the vehicle windshield protective device is engaged with the vehicle; and wherein the windshield wiper flap may substantially prevent frost, ice, and snow from adhering to the one or more windshield wipers. The device may further comprise: one or more full side straps; and wherein the one or more full side straps may be configured to engage with one or more side mirrors of the vehicle. The device may further comprise: a windshield wiper flap; wherein the windshield wiper flap may be configured to substantially cover one or more windshield wipers of a vehicle when the vehicle windshield protective device is engaged with the vehicle; and wherein the windshield wiper flap may substantially prevent frost, ice, and snow from adhering to the one or more windshield wipers. The at least one cover portion may be comprised of a Polyvinyl Chloride coating; wherein the Polyvinyl Chloride coating may be configured to make the at least one cover portion remain flexible in temperatures below 0° C. The one or more side mirror straps, the at least one wind strap, and the one or more full side straps may be elastic, such that, when the vehicle windshield protective device engages with the vehicle, the at least one cover portion is held tightly in place on the windshield of the vehicle. The at least one wind strap may be removably connected to the at least one cover portion. The at least one cover portion may be further comprised of one or more wind strap attachments; and wherein the one or more wind strap attachments are configured to removeably fasten the at least one wind strap to the at least one cover portion. A portion of said at least one wind strap may be configured to pass through an interior of said vehicle.

Another embodiment may be an improved vehicle windshield protective device comprising at least one cover portion, one or more side mirror straps, the improvements comprising: one or more full side straps; wherein the at least one cover portion is configured to substantially cover an outer surface of a windshield of a vehicle; wherein the one or more side mirror straps are configured to engage with one or more side mirrors of the vehicle; wherein the one or more full side straps are configured to engage with one or more side mirrors of the vehicle; wherein the cover portion is configured to substantially prevent frost, ice, and snow from adhering to the windshield when the vehicle windshield protective device engage with the vehicle. The device may further comprise a windshield wiper flap; wherein the windshield wiper flap is configured to substantially cover one or more windshield wipers of a vehicle when the vehicle windshield protective device is engaged with the vehicle; wherein the windshield wiper flap is configured to substantially prevent frost, ice, and snow from adhering to one or more windshield wipers. The device may further comprise at least one wind strap; wherein the at least one wind strap may be configured to fasten onto a top portion of the vehicle; and wherein the at least one wind strap may be configured to prevent the vehicle windshield protective device from being blown off the vehicle. The at least one wind strap may be configured to removably connect to the at least one cover portion. The at least one cover portion may be further comprised of one or more wind strap attachments; and wherein the one or more wind strap attachments may be configured to removeably fasten the at least one wind strap to the at least one cover portion. A portion of the at least one wind strap may be configured to pass through an interior of the vehicle. The device may further comprise a windshield wiper flap; wherein the windshield wiper flap is configured to substantially cover one or more windshield wipers of a vehicle when the vehicle windshield protective device is engaged with the vehicle; and wherein the windshield wiper flap is configured to substantially prevent frost, ice, and snow from adhering to the one or more windshield wipers. The at least one cover portion may be comprised of a Polyvinyl Chloride coating; wherein the Polyvinyl Chloride coating may be configured to make the at least one cover portion remain flexible in temperatures below 0° C. The one or more side mirror straps, the at least one wind strap, and the one or more full side straps may be elastic, such that, when the vehicle windshield protective device engages with the vehicle, the at least one cover portion may be held tightly in place on the windshield of the vehicle.

Another embodiment may be an improved vehicle windshield protective device comprising at least one cover portion, one or more side mirror straps, the improvements comprising: one or more mirror covers; wherein the at least one cover portion is configured to substantially cover an outer surface of a windshield of a vehicle; wherein the one or more side mirror straps are configured to engage with one or more side mirrors of the vehicle; wherein the one or more full side straps are configured to engage with one or more side mirrors of the vehicle; wherein the cover portion is configured to substantially prevent frost, ice, and snow from adhering to the windshield when the vehicle windshield protective device engages with the vehicle; and wherein the one or more mirror covers are configured to substantially cover the one or more side mirrors of the vehicle. The device may further comprise: a windshield wiper flap; wherein the windshield wiper flap may be configured to substantially cover one or more windshield wipers of a vehicle when the vehicle windshield protective device is engaged with the vehicle; wherein the windshield wiper flap may be configured to substantially prevent frost, ice, and snow from adhering to one or more windshield wipers; and wherein the one or more mirror covers may be removable.

It is an object to provide a vehicle windshield protective device or cover that covers the entire windshield of the vast majority of vehicles, including trucks and SUVs. The device may have side mirror covers and if it does they are preferably configured to cover the side mirrors of most vehicles.

It is an object to provide a vehicle windshield protective device that is made from materials that safely and effectively protect the vehicle windshield.

It is an object to provide a vehicle windshield protective device that remains firmly attached to a vehicle under strong winds.

It is an object to provide a vehicle windshield protective device that is easy to store.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the vehicle windshield protective device showing a wind strap and a windshield wiper flap.

FIG. 2 is an illustration of a perspective view of one embodiment of the vehicle windshield protective device showing a wind strap.

FIG. 3 is an illustration of a perspective view of another embodiment of the vehicle windshield protective device showing full side straps and a windshield wiper flap.

FIG. 4 is an illustration of a perspective view of another embodiment of the vehicle windshield protective device showing full side straps.

FIG. 5 is an illustration of a perspective view of another embodiment of the vehicle windshield protective device showing mirror covers and a windshield wiper flap.

FIG. 6 is an illustration of a perspective view of another embodiment of the vehicle windshield protective device showing mirror covers.

FIG. 7 is an illustration of a perspective view of another embodiment of the vehicle windshield protective device.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

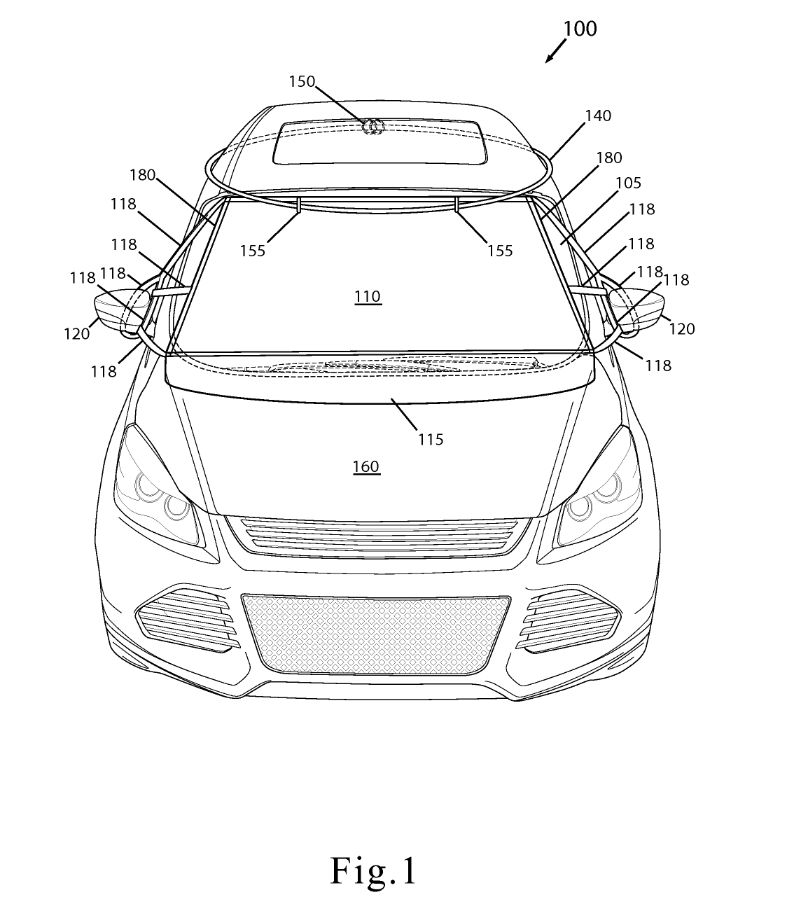

FIG. 1 is an illustration of a perspective view of one embodiment of the vehicle windshield protective device, showing a wind strap and a windshield wiper flap. As shown in FIG. 1, the vehicle windshield protective device 100 may comprise: a cover portion 110, side mirror straps 118, wind strap 140, windshield wiper flap 115, wind strap attachments 155, wind strap connector 150, and support members 180. As shown, the cover portion 110 may be configured to substantially cover an outer surface of a windshield 105 of the vehicle 160. The purpose of the cover 110 is to substantially prevent frost, ice, and snow from adhering to the windshield 105. The cover 110 is most effective at preventing ice or frost build up when it maintains direct contact with the glass of the windshield 105. In order to do this, the cover portion 110 is held firmly in place by a series of straps, including side mirror straps 118, and wind strap 140. However, as shown in the other FIGS., not all the straps need be used in every embodiment. It should be understood that although FIG. 1 shows two side mirror straps 118 and only one wind strap 140, the side mirror straps and wind strap may be as few as one of each or more than two. FIG. 1 also shows that the side mirror straps 118 may be configured to engage with one or more side mirrors 120 of the vehicle 160. In this manner, the device 100 removably connects to the vehicle 160 and is held firmly and securely in place. The straps are preferably made from high grade elastic that allows them to returnably stretch and hook around the side mirrors or other vehicle parts while holding the cover portion taut. In a preferred embodiment, the elastic can withstand low and high temperatures and repeated donnings.

As shown in FIG. 1, the wind strap 140 may be configured to pass through the interior of the vehicle 160 and prevent the vehicle windshield protective device 100 from being blown off the vehicle 160. FIG. 1 shows that the wind strap 140 may be removably attached to the cover portion 110 via the wind strap attachments 155, which may be loops or holes located on the cover portion 100. The wind strap 140 may loop through the wind strap attachments 155, pass through the interior of the vehicle 160, and then have the ends connect at connector 150. The wind strap 140 may also prevent the vehicle windshield protective device 100 from being stolen from the vehicle 160.

As shown in FIG. 1 the device 100 may include a windshield wiper flap 115, which may substantially prevent frost, ice, and snow from adhering to one or more windshield wipers.

The cover portion 110 and/or the windshield wiper flap 115 may comprise a Polyvinyl Chloride (PVC) coating. The PVC coating generally helps the cover portion 110 and/or windshield wiper flap 115 remain flexible in temperatures below 0° C. and generally makes the cover portion 110 extremely durable and water resistant. The PVC coating may be on an interior surface of the cover portion 110, such that the PVC coating directly contacts the vehicle windshield 105. The cover portion 110 may be made from one or more layers of a durable, weather resistant material such as canvas, which may then be coated with the PVC coating.

FIG. 1 also shows how the vehicle windshield protective device 100 may comprise one or more support members 180. The support members 180, which may be a rigid rod or other structure, may provide side support to the vehicle windshield protective device 100 and allow the device to be easily and tightly rolled up for storage.

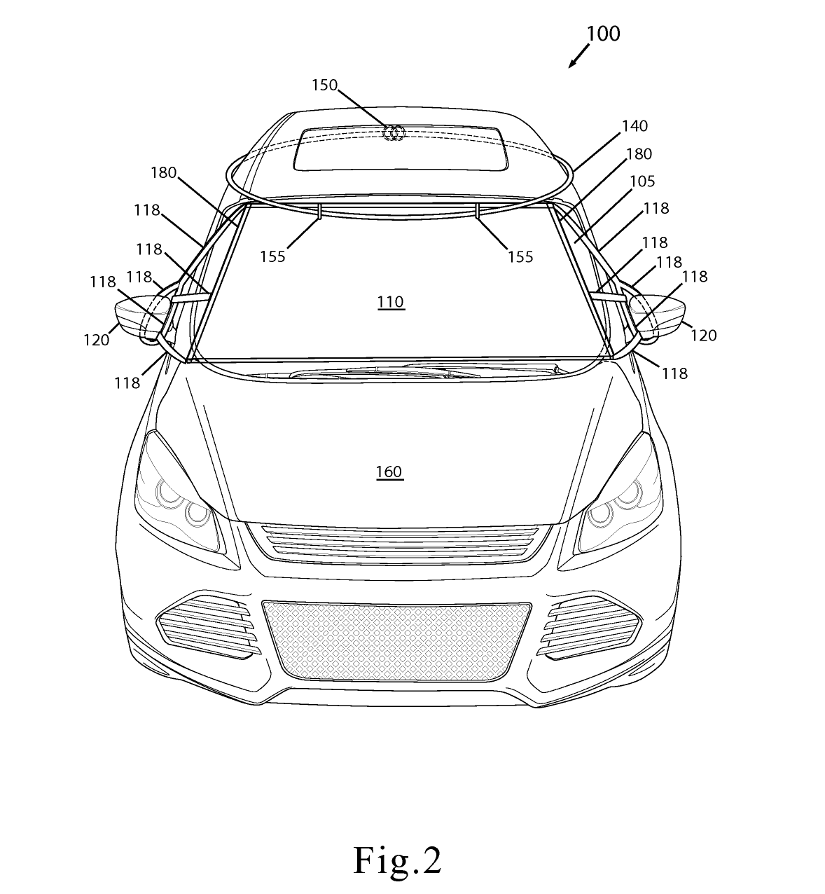

FIG. 2 is an illustration of a perspective view of one embodiment of the vehicle windshield protective device showing a wind strap. As shown in FIG. 2, the vehicle windshield protective device 100 may comprise: a cover portion 110, side mirror straps 118, wind strap 140, wind strap attachments 155, wind strap connector 150, and support member 180.

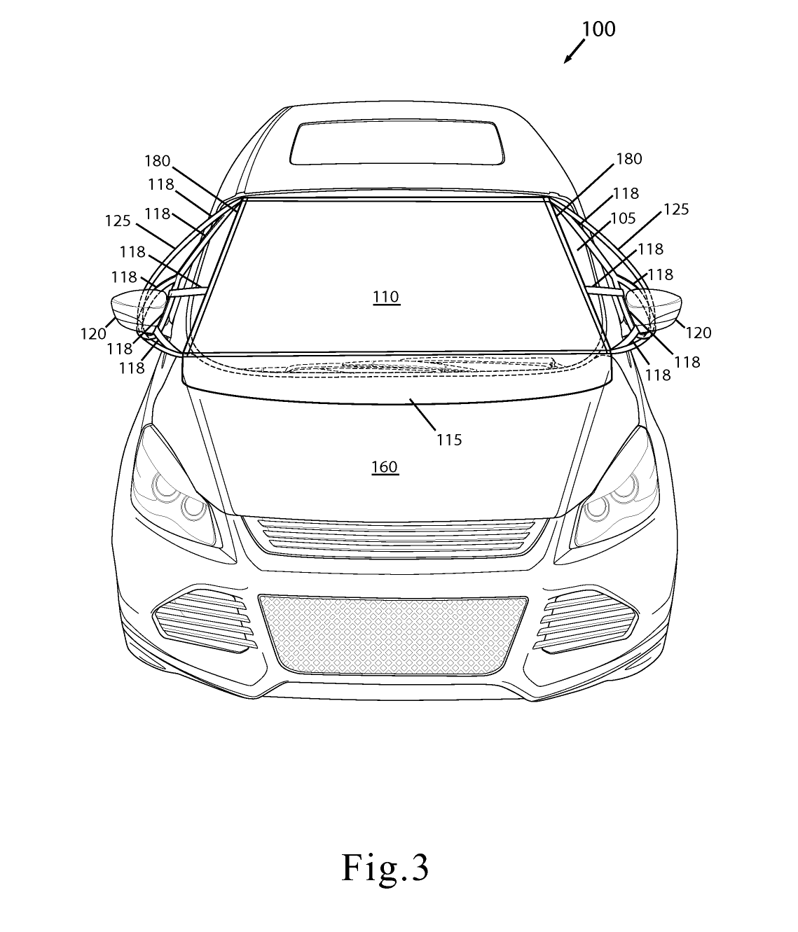

FIG. 3 is an illustration of a perspective view of another embodiment of the vehicle windshield protective device showing full side straps and a windshield wiper flap. As shown in FIG. 3, the vehicle windshield protective device 100 may comprise: a cover portion 110, side mirror straps 118, windshield wiper flap 115, full side straps 125, and support members 180. The cover portion 110 may be held firmly in place by a series of straps, including the side mirror straps 118 and full side straps 125. It should be understood, however, that although FIG. 3 shows two side mirror straps 118 and two full side straps 125, there may be as few as one of each or more than two. FIG. 3 also shows that the side mirror straps 118 and the full side straps may be configured to engage with one or more side mirrors 120 of the vehicle 160. As shown in FIG. 3 the device 100 may include a windshield wiper flap 115, which may substantially prevent frost, ice, and snow from adhering to one or more windshield wipers.

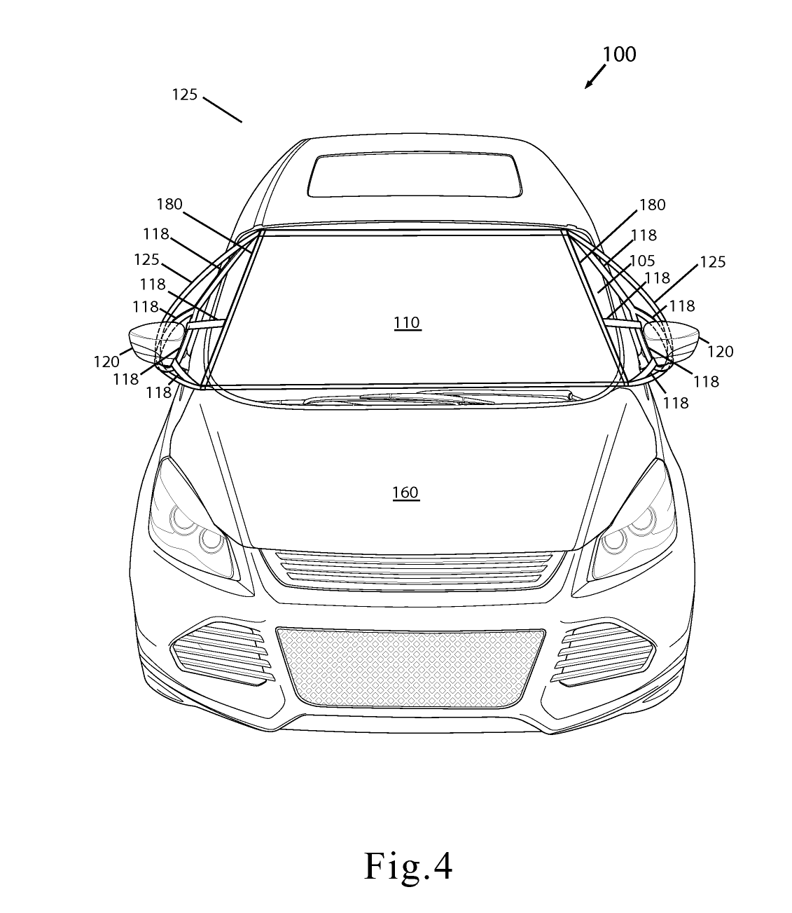

FIG. 4 is an illustration of a perspective view of another embodiment of the vehicle windshield protective device showing full side straps. As shown in FIG. 4, the vehicle windshield protective device 100 may comprise a cover portion 110, side mirror straps 118, full side straps 125, and support members 180.

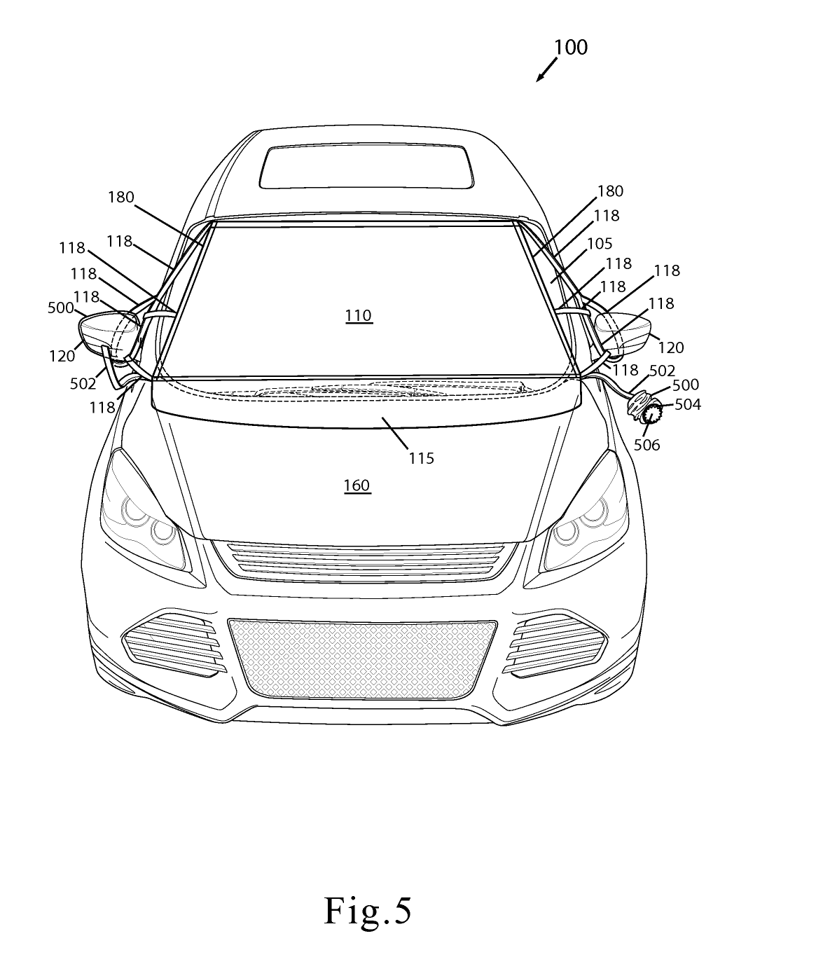

FIG. 5 is an illustration of a perspective view of another embodiment of the vehicle windshield protective device showing mirror covers and a windshield wiper flap. As shown in FIG. 5, the vehicle windshield protective device 100 may comprise: a cover portion 110, side mirror straps 118, windshield wiper flap 115, support members 180, side mirror covers 500, side mirror cover attachments 502, bands 504, and openings 506. The cover portion 110 may be held firmly in place by a series of straps and covers, including side mirror straps 118, side mirror covers 500. It should be understood, however, that although FIG. 5 shows that there are two side mirror straps 118 and two side mirror covers, there may be as few as one of each or more than two. FIG. 5 shows that the side mirror straps 118 and the side mirror covers 500 may be configured to engage with one or more side mirrors 120 of the vehicle 160. In this manner, the vehicle windshield protective device 100 removably connects to the vehicle 160 and may be held firmly and securely in place.

As shown in FIG. 5, the side mirror covers 500 may be attached to the cover portion 110 by side mirror cover attachments 502. The side mirror covers 500 may be removably attached to cover portion 110 or another portion of the vehicle windshield protective device 100. Any removably attachment device may be used, including without limitation, hook and eye, hook and loop fasteners, snaps, latches, buttons, or the like. Each of the side mirror covers 500 may comprise an opening 506 and a band 504. The side mirrors 120 preferably fit into opening 506 such that the entire mirror 120 is covered by mirror cover 500. The opening 506 may be defined by a band 504, which may be elastic, and which may be configured to expand or stretch around the mirror 120 and then contract to securely hold the cover 500 onto mirror 120. The side mirror covers 500 are configured to fit around most side vehicle mirrors 120. The side mirror covers 500 generally protect the mirrors 120 from frost, ice, and snow. Finally, as shown in FIG. 5 the device 100 may include a windshield wiper flap 115, which may substantially prevent frost, ice, and snow from adhering to one or more windshield wipers.

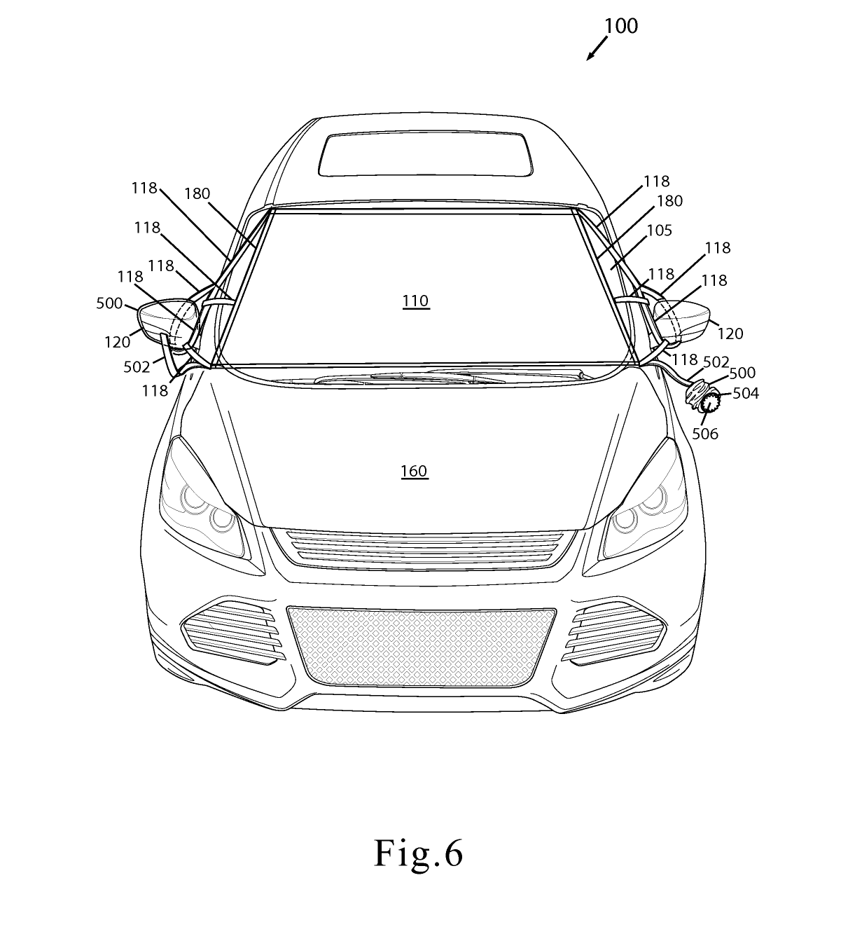

FIG. 6 is an illustration of a perspective view of another embodiment of the vehicle windshield protective device showing mirror covers. As shown in FIG. 6, the vehicle windshield protective device 100 may comprise: a cover portion 110, side mirror straps 118, full side straps 125, support members 180, side mirror covers 500, side mirror cover attachments 502, bands 504, and openings 506.

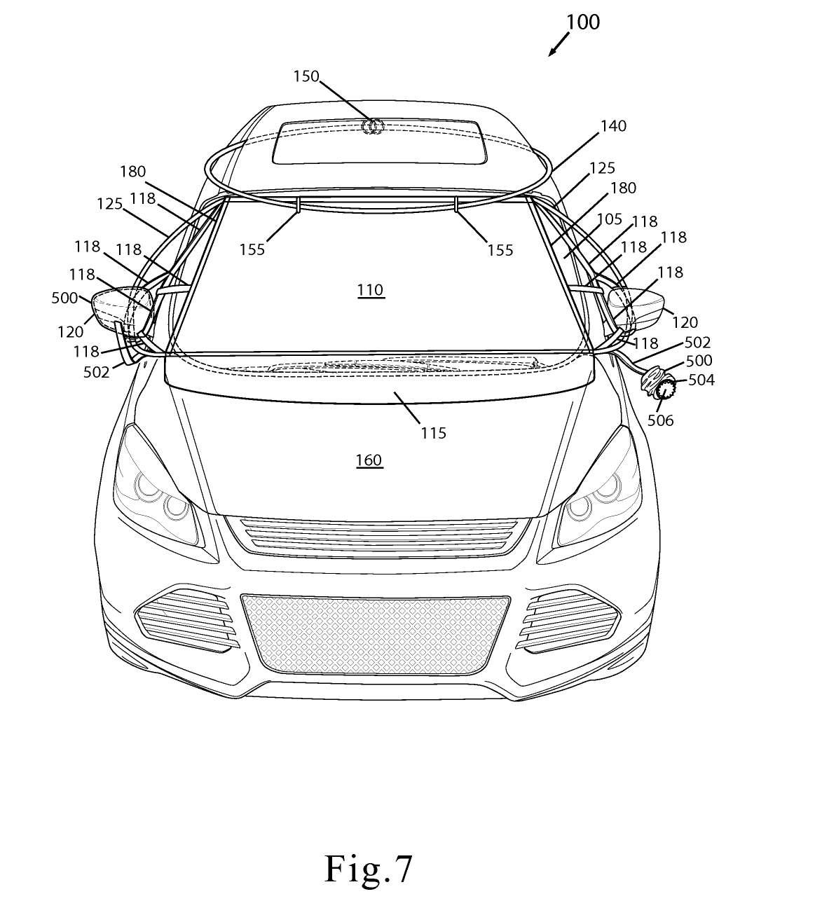

FIG. 7 is an illustration of a perspective view of another embodiment of the vehicle windshield protective device. As shown in FIG. 7, the vehicle windshield protective device 100 may comprise: a cover portion 110, side mirror straps 118, wind strap 140, windshield wiper flap 115, full side straps 125, wind strap attachments 155, wind strap connector 150, support members 180, side mirror covers 500, side mirror cover attachments 502, bands 504, and openings 506. The cover portion 110, which is shown as a single piece, may be more than one piece.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. An improved vehicle windshield protective device comprising at least one cover portion and one or more side mirror straps, the improvements comprising:
at least one wind strap;
wherein said at least one cover portion is configured to substantially cover an outer surface of a windshield of a vehicle;
wherein said one or more side mirror straps are configured to engage with one or more side mirrors of said vehicle;
wherein said at least one wind strap prevents said vehicle windshield protective device from being blown off said vehicle;
wherein said cover portion substantially prevents frost, ice, and snow from adhering to said windshield.

2. The vehicle windshield protective device, according to claim 1, further comprising:
a windshield wiper flap;
wherein said windshield wiper flap is configured to substantially cover one or more windshield wipers of a vehicle when said vehicle windshield protective device is engaged with said vehicle;
wherein said windshield wiper flap substantially prevents frost, ice, and snow from adhering to said one or more windshield wipers.

3. The vehicle windshield protective device, according to claim 1, further comprising:
one or more full side straps;
wherein said one or more full side straps are configured to engage with one or more side mirrors of said vehicle.

4. The vehicle windshield protective device, according to claim 3, further comprising:
a windshield wiper flap;
wherein said windshield wiper flap is configured to substantially cover one or more windshield wipers of a vehicle when said vehicle windshield protective device is engaged with said vehicle;
wherein said windshield wiper flap substantially prevents frost, ice, and snow from adhering to said one or more windshield wipers.

5. The vehicle windshield protective device, according to claim 3, wherein said at least one cover portion is comprised of a Polyvinyl Chloride coating;
wherein said Polyvinyl Chloride coating is configured to make said at least one cover portion remain flexible in temperatures below 0° C.

6. The vehicle windshield protective device, according to claim 3, wherein said one or more side mirror straps, said at least one wind strap, and said one or more full side straps are elastic, such that, when said vehicle windshield protective device engages with said vehicle, said at least one cover portion is held tightly in place on said windshield of said vehicle.

7. The vehicle windshield protective device, according to claim 1, wherein said at least one wind strap is removably connected to said at least one cover portion.

8. The vehicle windshield protective device, according to claim 7, wherein said at least one cover portion is further comprised of one or more wind strap attachments; and
wherein said one or more wind strap attachments are configured to removeably fasten said at least one wind strap to said at least one cover portion.

9. The vehicle windshield protective device, according to claim 8, wherein a portion of said at least one wind strap is configured to pass through an interior of said vehicle.

10. An improved vehicle windshield protective device comprising at least one cover portion, one or more side mirror straps, the improvements comprising:
one or more full side straps;
wherein said at least one cover portion is configured to substantially cover an outer surface of a windshield of a vehicle;
wherein said one or more side mirror straps are configured to engage with one or more side mirrors of said vehicle;
wherein said one or more full side straps are configured to engage with one or more side mirrors of said vehicle;
wherein said cover portion is configured to substantially prevent frost, ice, and snow from adhering to said windshield when said vehicle windshield protective device engage with said vehicle.

11. The vehicle windshield protective device, according to claim 10, further comprising:
a windshield wiper flap;
wherein said windshield wiper flap is configured to substantially cover one or more windshield wipers of a vehicle when said vehicle windshield protective device is engaged with said vehicle;
wherein said windshield wiper flap is configured to substantially prevent frost, ice, and snow from adhering to one or more windshield wipers.

12. The vehicle windshield protective device, according to claim 10, further comprising:
at least one wind strap;
wherein said at least one wind strap is configured to fasten onto a top portion of said vehicle;
wherein said at least one wind strap is configured to prevent said vehicle windshield protective device from being blown off said vehicle.

13. The vehicle windshield protective device, according to claim 12, wherein said at least one wind strap is configured to removably connect to said at least one cover portion.

14. The vehicle windshield protective device, according to claim 13, wherein said at least one cover portion is further comprised of one or more wind strap attachments; and
wherein said one or more wind strap attachments are configured to removeably fasten said at least one wind strap to said at least one cover portion.

15. The vehicle windshield protective device, according to claim 14, wherein a portion of said at least one wind strap is configured to pass through an interior of said vehicle.

16. The vehicle windshield protective device, according to claim 12, further comprising:
a windshield wiper flap;
wherein said windshield wiper flap is configured to substantially cover one or more windshield wipers of a vehicle when said vehicle windshield protective device is engaged with said vehicle; and
wherein said windshield wiper flap is configured to substantially prevent frost, ice, and snow from adhering to said one or more windshield wipers.

17. The vehicle windshield protective device, according to claim 12, wherein said at least one cover portion is comprised of a Polyvinyl Chloride coating;
wherein said Polyvinyl Chloride coating is configured to make said at least one cover portion remain flexible in temperatures below 0° C.

18. The vehicle windshield protective device, according to claim 12, wherein said one or more side mirror straps, said at least one wind strap, and said one or more full side straps are elastic, such that, when said vehicle windshield protective device engages with said vehicle, said at least one cover portion is held tightly in place on said windshield of said vehicle.

19. An improved vehicle windshield protective device comprising at least one cover portion, one or more side mirror straps, the improvements comprising:
one or more mirror covers;
wherein said at least one cover portion is configured to substantially cover an outer surface of a windshield of a vehicle;
wherein said one or more side mirror straps are configured to engage with one or more side mirrors of said vehicle;
wherein said one or more full side straps are configured to engage with one or more side mirrors of said vehicle;
wherein said cover portion is configured to substantially prevent frost, ice, and snow from adhering to said windshield when said vehicle windshield protective device engages with said vehicle; and
wherein said one or more mirror covers are configured to substantially cover said one or more side mirrors of said vehicle.

20. The vehicle windshield protective device, according to claim 10, further comprising:
a windshield wiper flap;
wherein said windshield wiper flap is configured to substantially cover one or more windshield wipers of a vehicle when said vehicle windshield protective device is engaged with said vehicle;
wherein said windshield wiper flap is configured to substantially prevent frost, ice, and snow from adhering to one or more windshield wipers; and
wherein said one or more mirror covers are removable.
